(19) United States
(12) Patent Application Publication
(10) Pub. No.: US 2026/0160357 A1
(43) Pub. Date: Jun. 11, 2026

(54) TANK CAR OUTLET VALVE ARRANGEMENT

(71) Applicant: A. Stucki Company, Moon Township, PA (US)

(72) Inventor: Vedran Dzolovic, Norridge, IL (US)

(73) Assignee: A. Stucki Company, Moon Township, PA (US)

(21) Appl. No.: 19/410,446

(22) Filed: Dec. 5, 2025

Related U.S. Application Data
(60) Provisional application No. 63/728,335, filed on Dec. 5, 2024.

(51) Int. Cl. F16K 35/10

(52) U.S. Cl. CPC F16K 35/10

(57) ABSTRACT

Disclosed is a valve stem locking mechanism for an outlet valve. The valve stem locking mechanism includes a torque resistance couple configured to restrict or prevent rotation of a stem and associated flow control element of the outlet valve when in the outlet valve is in the closed position.

### CROSS REFERENCE TO RELATED APPLICATIONS

This patent application is related to and claims the benefit of priority of U.S. Provisional Application No. 63/728,335, filed on Dec. 5, 2024, which is related to U.S. application Ser. No. 14/744,628 filed Jun. 19, 2015, now U.S. Pat. No. 10,274,101; U.S. application Ser. No. 16/275,022 filed Feb. 13, 2019, now U.S. Pat. No. 10,760,709 and U.S. application Ser. No. 16/874,829 filed May 15, 2020, now U.S. Pat. No. 11,248,720. The entire context of each of the above identified applications is hereby incorporated by reference as if fully set forth herein.

### BACKGROUND

Railroad tank cars used to transport liquid products include a valve, often referred to as the “bottom outlet valve” for unloading the tank car content. An exemplary bottom outlet valve may include a rotatable ball mechanism within a valve housing attached to the bottom of the tank or containment vessel. The rotatable ball within the valve housing may be operable between a closed and an open position by a valve shaft or stem affixed to the ball and rotatable about an axis. In the closed position the valve is sealed. When open, the vessel content may flow through the valve.

Traditionally, the bottom outlet valve may be operated manually using an operating handle or mechanism affixed to the car in operative association with the bottom outlet valve. Such mechanisms, disclosed and claimed in the above-mentioned patents are commercially available from Salco Products, Inc., Lemont, Illinois.

Safety concerns dictate that precaution be taken to prevent inadvertent or accidental discharge of product through the bottom outlet valve. Toward that end, when not in use, the handle mechanism may be isolated or disengaged from the valve stem of the bottom outlet valve. Also, a valve locking mechanism may be employed to prevent inadvertent valve opening.

Examples of mechanical configurations that address these precautions are fully disclosed in the above identified patents and that subject matter is, as previously stated, incorporated herein by reference herein, for all purposes, as if fully set forth.

With an effective date of Jul. 1, 2024, the AAR Manual of Standards and Recommended Practices has provided that the valve locking mechanism must minimally withstand an operating torque of 800 ft-lbs. about the valve stem. The disclosure below presents solutions to this new level of protection.

### SUMMARY

An outlet valve for a railroad tank car may include a valve stem locking mechanism comprising at least one torque resistance couple retaining the outlet valve in the closed position against significant external forces. The at least one torque resistance couple may include a rotatable force transmission element and a stationary force receiving element to selectively and releasably lock the stem of the outlet valve and associated flow control element against inadvertent dislodgment to an open position. The force transmission and receiving elements may be of sufficient strength to withstand valve opening forces imparting up to 800 ft. lbs. of torque to the valve stem.

In an embodiment a locking mechanism for a tank car bottom outlet valve includes a torque resistance couple comprising a force transmission surface along an outer peripheral surface of a disc connected for rotation with the valve stem and a stationary force receiving surface operatively associated with the force transmission surface to preclude rotation of the valve stem toward an open position.

In an embodiment, in accordance with the disclosure, the at least one torque resistance couple includes a force receiving surface secured to the body of the outlet valve. In another, the at least one torque resistance couple includes a force receiving surface secured to the skid of the tank car. In a further embodiment, the at least one torque resistance couple includes a force receiving surface formed on a plate secured to the skid of the tank car.

In an embodiment, the at least one force receiving surface is formed on a block secured to the skid of the tank car. In another embodiment, the at least one force receiving surface is formed on an angle bracket secured to the skid of the tank car.

In other embodiments, the locking mechanism includes plural torque resistance couples each comprising a force transmission surface operatively associated with a force receiving surface.

In yet another embodiment, the stem locking mechanism includes torque resistance couples to preclude rotation of the stem in either direction.

In each embodiment, the at least one force transmission surface is movable relative to the force receiving surface to permit rotation of the valve stem to a valve open position.

An exemplary embodiment relates to a valve stem locking mechanism for an outlet valve including a stem and associated flow control element in which rotation of the stem controls movement of the associated flow control element to selectively transition the outlet valve to and from a closed position and an open position, wherein the stem extends from a surface of the outlet valve. The valve stem locking mechanism includes a coupling connectable to the stem and configured for axially translation along the stem. The valve stem locking mechanism includes at least one torque resistance couple configured to restrict or prevent rotation of the stem and associated flow control element when in the outlet valve is in the closed position. The at least one torque resistance couple includes a rotatable force transmission element formed on the coupling. The at least one torque resistance couple includes a stationary force receiving element formed on a portion of the outlet valve in proximity to the stem. When the coupling is axially translated along the stem towards the valve outlet, the rotatable force transmission element and the stationary force receiving element are in a same rotational path so as to co-act by physically abutting against each other to restrict or prevent rotation of the stem. When the coupling is axially translated along the stem away from the valve outlet, the rotatable force transmission element and the stationary force receiving element are not in the same rotational path and do not restrict or prevent rotation of the stem.

In some embodiments, the rotatable force transmission element is a cam disc with a flat. The stationary force receiving element is a stationary plate with a flat. The flat of the rotatable force transmission element and the flat of the stationary force receiving element co-act by physically abutting against each to restrict or prevent rotation of the stem.

In some embodiments, the rotatable force transmission element is a cam disc with a flat. The stationary force receiving element is a resistor block with a flat. The flat of the rotatable force transmission element and the flat of the stationary force receiving element co-act by physically abutting against each to restrict or prevent rotation of the stem.

In some embodiments, the rotatable force transmission element is a cam disc with a flat. The stationary force receiving element includes two resistor blocks, each with a flat. The flat of the rotatable force transmission element and the flats of the stationary force receiving element co-act by physically abutting against each to restrict or prevent rotation of the stem.

In some embodiments, the valve stem locking mechanism includes a spring to bias the coupling away from the outlet valve.

An exemplary embodiment relates to a valve stem locking mechanism for an outlet valve including a stem and associated flow control element in which rotation of the stem controls movement of the associated flow control element to selectively transition the outlet valve to and from a closed position and an open position, wherein the stem extends from a surface of the outlet valve. The valve stem locking mechanism includes a coupling connectable to the stem. The valve stem locking mechanism includes plural torque resistance couples configured to restrict or prevent rotation of the stem and associated flow control element when in the outlet valve is in the closed position. The plural torque resistance couples include a rotatable force transmission element formed on the coupling and configured for axially translation along the stem. The plural torque resistance couples include a stationary force receiving element formed on a portion of the outlet valve in proximity to the stem. Rhen the rotatable force transmission element is axially translated along the stem towards the valve outlet, the rotatable force transmission element and the stationary force receiving element are in a same rotational path so as to co-act by physically abutting against each other to restrict or prevent rotation of the stem. When the rotatable force transmission element is axially translated along the stem away from the valve outlet, the rotatable force transmission element and the stationary force receiving element are not in the same rotational path and do not restrict or prevent rotation of the stem.

In some embodiments, the rotatable force transmission element is a locking bracket with a hole to receive the stem in axial translation and plural flats. The stationary force receiving element is a mounting plate with a plural receiving surfaces/ The plural flats of the rotatable force transmission element and the plural receiving surface of the stationary force receiving element co-act by physically abutting against each to restrict or prevent rotation of the stem.

In some embodiments, the valve stem locking mechanism includes a spring to bias the rotatable force transmission element away from the outlet valve.

An exemplary embodiment relates to a valve stem locking mechanism for an outlet valve including a stem and associated flow control element in which rotation of the stem controls movement of the associated flow control element to selectively transition the outlet valve to and from a closed position and an open position, wherein the stem extends from a surface of the outlet valve. The valve stem locking mechanism includes a coupling connectable to the stem, the coupling including a coupling bore. The valve stem locking mechanism includes a sleeve connectable to a portion of the outlet valve, the sleeve including a sleeve bore, and the sleeve configured to receive the coupling in a freely rotational arrangement. The valve stem locking mechanism includes a pin configured to be inserted through the coupling bore and the sleeve bore. When the pin is inserted through the coupling bore and the sleeve bore, the valve stem locking mechanism restricts or prevents rotation of the stem.

### DESCRIPTION OF THE DRAWINGS

FIG. 1 is a perspective view of an exemplary bottom outlet valve for a railroad tank car associated with a handle operating mechanism and incorporating a valve stem locking mechanism of the disclosure.

FIG. 2 is a perspective view, on an enlarged scale, of the bottom outlet valve of FIG. 1, showing the valve stem in the valve closed position.

FIG. 3 is a fragmentary perspective view of a portion of the valve handle operating mechanism of FIG. 1.

FIG. 4 is a perspective view, on an enlarged scale, of portions of the embodiment of FIG. 1.

FIG. 5 is a partially broken away plan view of the stem coupling and stem locking mechanism of the embodiment of FIG. 1.

FIG. 6 is a perspective view of a portion of the stem locking mechanism of the embodiment of FIG. 1.

FIG. 7 is a plan view of portions of the handle operating mechanism and stem locking mechanism of the embodiment of FIG. 1 in an alternative operational relationship.

FIG. 8 is a perspective view of another exemplary embodiment of a bottom outlet valve for a railroad tank car associated with a handle operating mechanism and incorporating a valve stem locking mechanism in accordance with the disclosure.

FIG. 9 is a perspective view from the opposite direction of the bottom outlet valve and handle operating mechanism of the embodiment of FIG. 8.

FIG. 10 is a perspective view of the mounting plate for attachment to the skid of a railroad tank car in the embodiment of FIG. 8.

FIG. 11 is a sectional side view, on an enlarged scale, of the bottom outlet valve and handle operating mechanism of the embodiment of FIG. 8 illustrating details of the valve stem locking mechanism of the disclosure.

FIG. 12 is a perspective view of the locking bracket of the stem locking mechanism of the embodiment of FIG. 8.

FIG. 13 is a perspective view of an embodiment of a bottom outlet valve for a railroad tank car associated with a handle operating mechanism incorporating a manual stem locking mechanism.

FIG. 14 is a partial plan view on an enlarged scale, illustrating details of the embodiment of FIG. 13.

FIG. 15 illustrates a component of the stem locking mechanism of the embodiment of FIG. 13.

FIG. 16 illustrates a further component of the stem locking mechanism of the embodiment of FIG. 13.

FIG. 17 illustrates another component of the stem locking mechanism of the embodiment of FIG. 13.

FIGS. 18-21 illustrate a stem locking mechanism in accordance with the disclosure similar to, but modified somewhat from, the embodiment illustrated in FIGS. 1-7. The bottom outlet valve, valve stem locking mechanism and handle operating mechanism are shown in relation to the protective skid of the tank or vessel of a railroad tank car as illustrated in FIGS. 8 and 13.

FIGS. 18 and 19 are respectively a plan and perspective view of the bottom outlet valve and handle operating mechanism of the embodiment of FIGS. 18-21 illustrating the valve stem locking mechanism in the stem locked position.

FIGS. 20 and 21 are respectively a plan and perspective view of the bottom outlet valve and handle operating mechanism of the embodiment of FIGS. 18 and 21 illustrating the valve stem locking mechanism positioned to permit movement of the valve stem to a valve open position.

FIGS. 22-25 illustrate a stem locking mechanism in accordance with the disclosure similar to, but modified somewhat from, the embodiment illustrated in FIGS. 18-21. The bottom outlet valve, valve stem locking mechanism and handle operating mechanism are shown in relation to the protective skid of the tank or vessel of a railroad tank car as illustrated in FIGS. 8 and 13.

FIGS. 22 and 23 are respectively a plan and perspective view of another embodiment of the bottom outlet valve and handle operating mechanism of the embodiment of FIGS. 22-25 illustrating the valve stem locking mechanism in the stem locked position.

FIGS. 24 and 25 are respectively a plan and perspective view of the embodiment of the bottom outlet valve and handle operating mechanism of the embodiment of FIGS. 22-25 illustrating the valve stem locking mechanism positioned to permit movement of the valve stem to a valve open position.

FIG. 26 is a perspective view of a valve stem coupling employed in the valve stem locking mechanism of the embodiments of FIGS. 18 to 25.

FIG. 27 is a plan view of another modification contemplated by the disclosure and useful to the valve stem locking mechanism of the embodiments of FIGS. 18 to 25.

### DETAILED DESCRIPTION OF THE ILLUSTRATED EMBODIMENTS

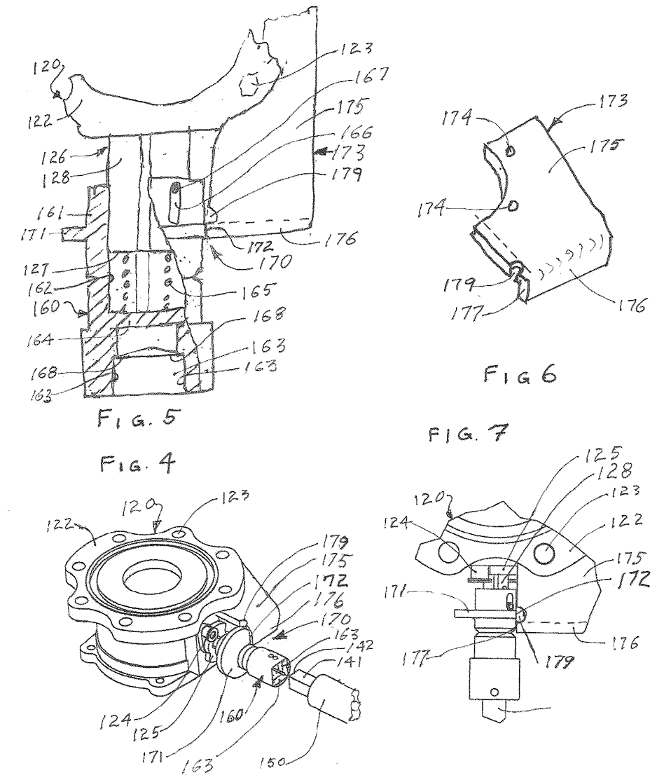

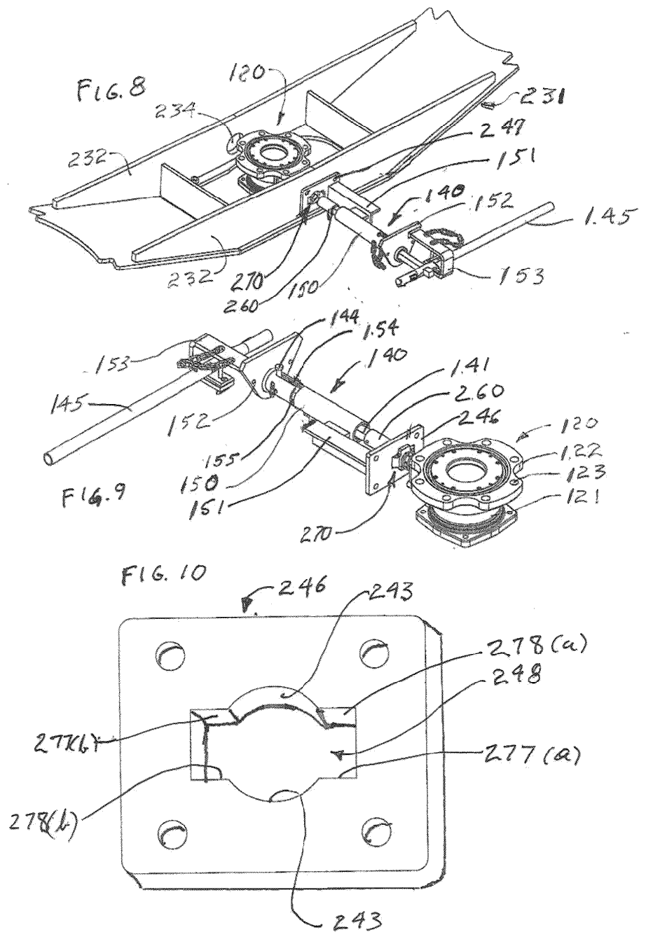

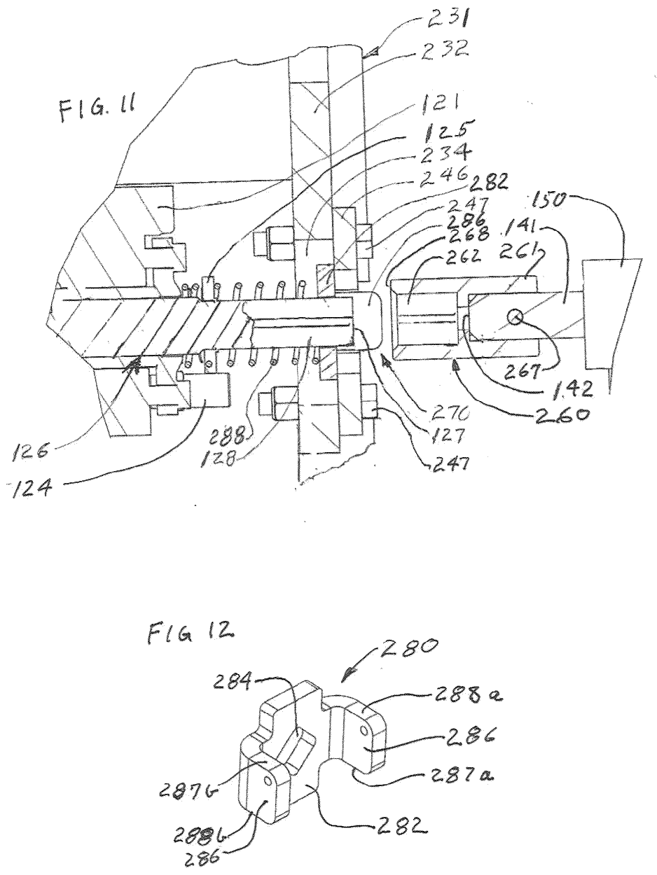

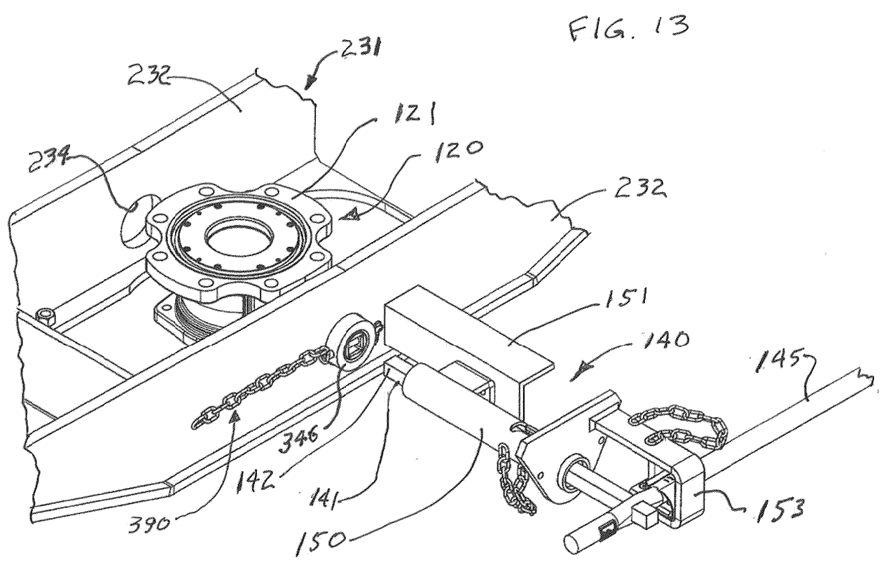

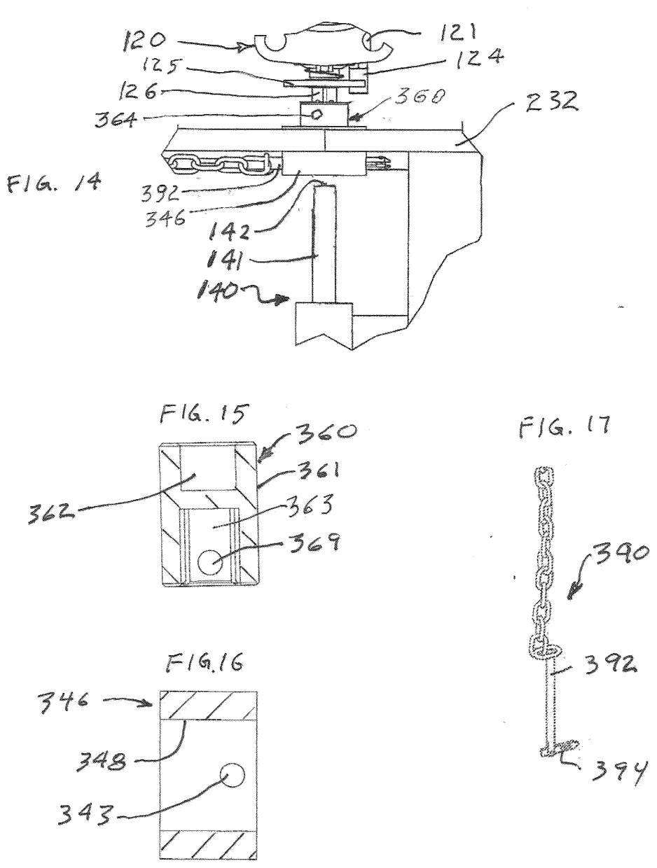

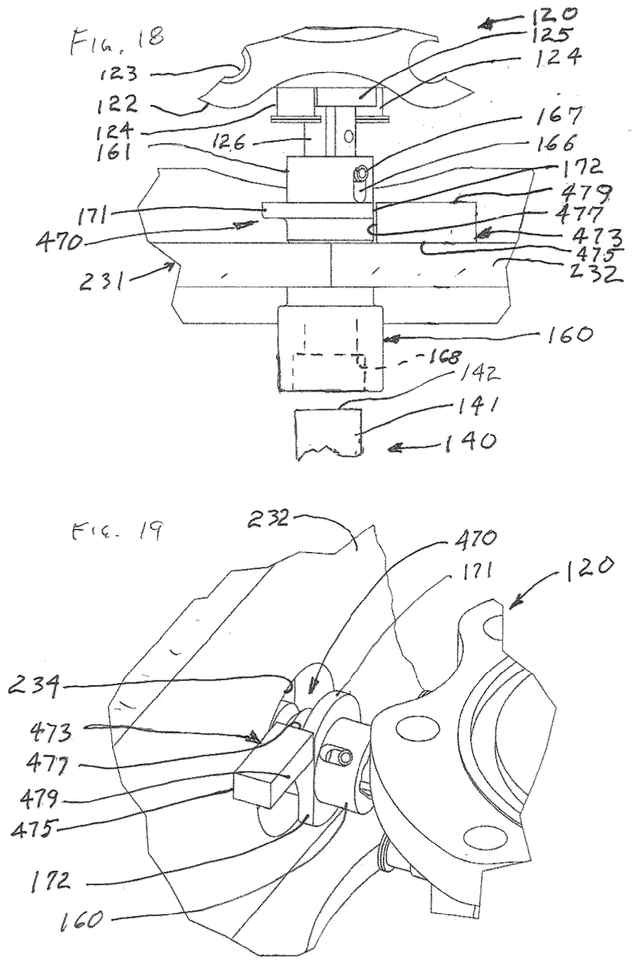

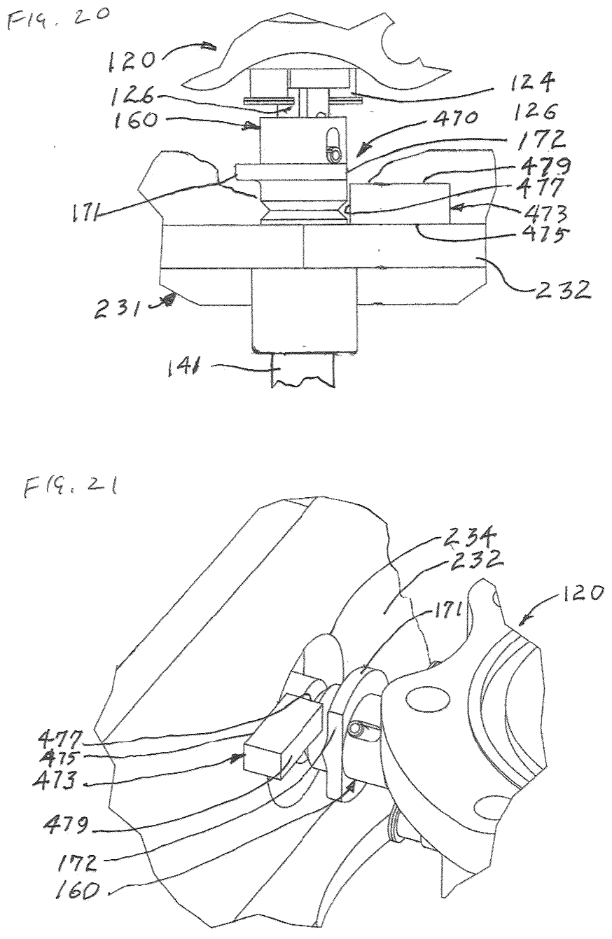

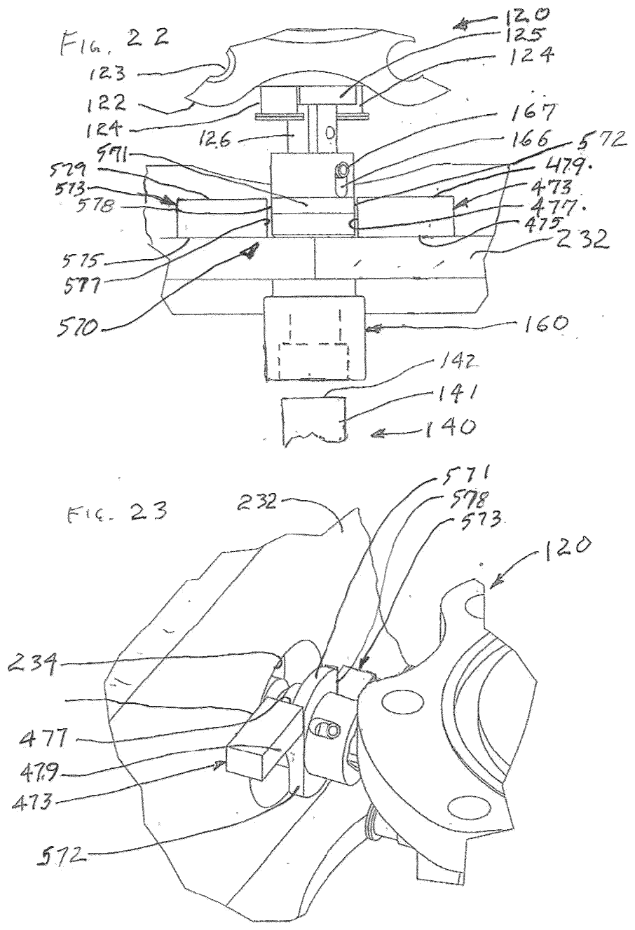

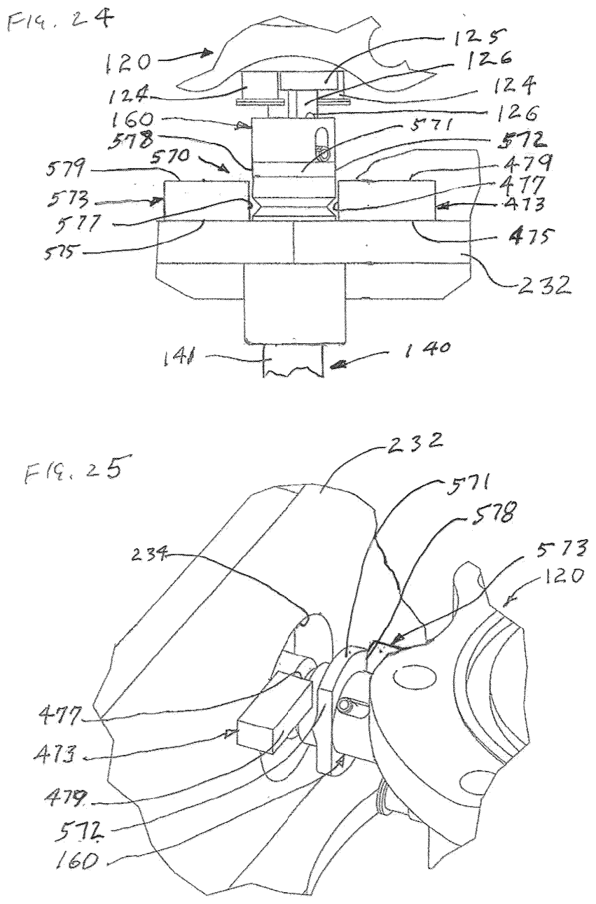

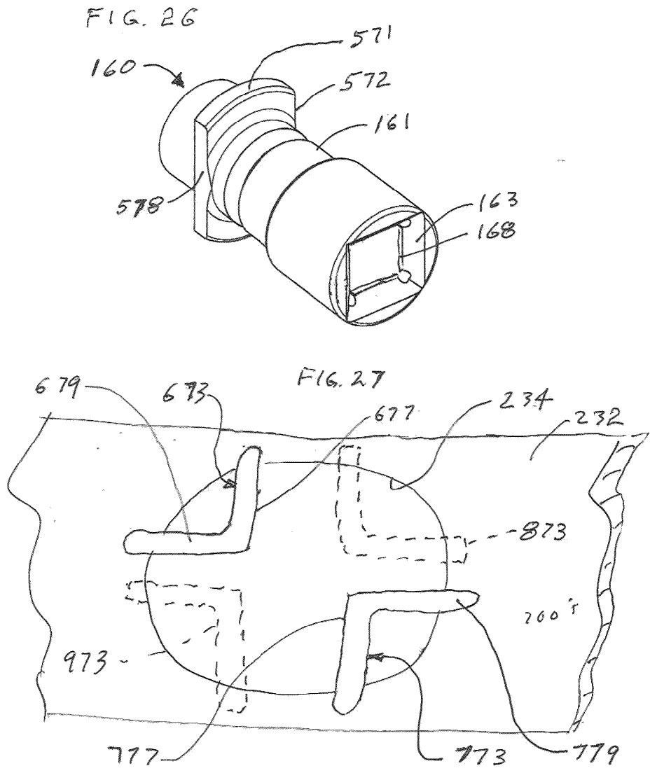

A railroad tank car for liquid lading may include a vessel equipped with a bottom outlet valve designated 120 in FIG. 2 to empty the vessel. A valve handle assembly generally designated 140 may be mounted in operative association to the valve 120 to open and close the valve. The components are known from the above identified US patents.

In accordance with the disclosure bottom outlet valve 120 disclosed herein is provided with a stem locking mechanism 170 to selectively and releasably restrict rotation of the stem 126 and associated flow control element when in the valve closed position.

As best illustrated in FIG. 2, bottom outlet valve 120 has a body 121 defining a flow passage. It includes an upper flange 122 having a plurality of holes 123 to secure the valve 120 to the tank car vessel. Internally, of body 121 the valve 120 includes a flow control element on a shaft rotatable about an axis to control flow. The flow control element may be a spherical ball, plate or other shape associated with an appropriate passage or through port to adjust flow between a closed, and fully open positions. A shaft extension or stem 126 having free end 127 extends out of body 121. Stem 126, seen in FIGS. 2 and 5, has a generally square cross-section defined by flats 128 to receive rotational operating forces.

Valve 120 is arranged such that movement of the flow control element between the valve closed and valve open positions is accomplished by rotation of stem 126 in an arc of 90°(degrees). As seen in FIG. 2, a pair of limit stops 124 are affixed to valve body 121. Stem 126 includes radial tabs 125 configured to engage limit stops 124 at the valve closed and valve fully open positions. As illustrated in FIG. 2, the radial tabs 125 include lateral edges 129 in abutting contact with stops 124 when valve stem 126 is in the valve closed position and opposite lateral edges 130 in abutting contact with stops 124 when valve stem 126 is in the valve fully open position. Notably with lateral edges 129 or lateral edges 130 of radial tabs 125 in abutting contact with limit stops 124 on valve body 121 valve stem 126 is precluded from further rotation beyond either the valve closed position or the valve fully open position.

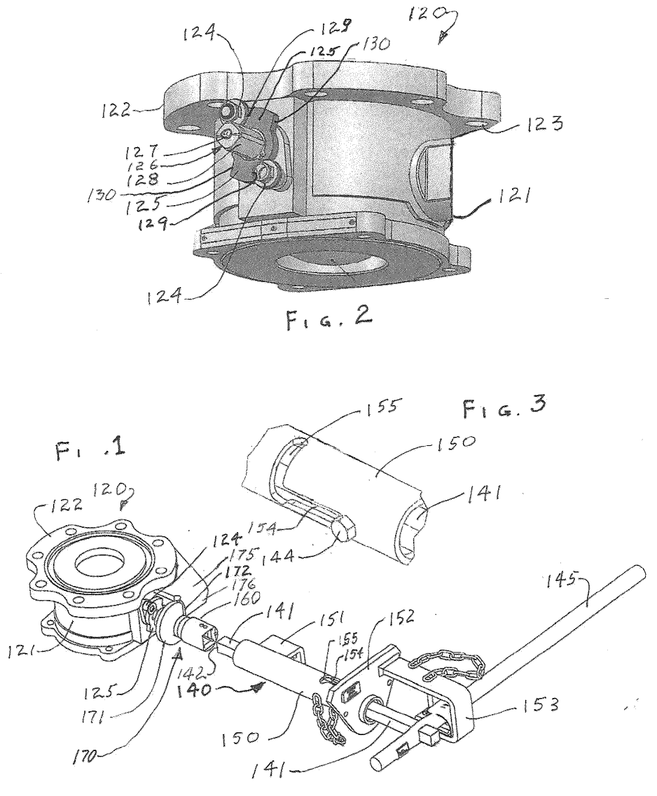

Referring to FIG. 1, valve handle assembly 140 includes a horizontally disposed support tube 150 for mounting to the tank or vessel in operative relation to the stem 126 using angle bracket 151 and weld plate 152. Angle bracket 151 and weld plate 152 may be welded to support tube 150 of valve handle assembly 140 and welded or otherwise secured to the tank car structure. As illustrated in FIG. 1, plate 152 may support handle securement bracket 153 within which operating handle 145 is stored when not being used.

Valve handle assembly 140 includes a valve handle 145 connected at an end of elongate operating shaft 141. Mounted in support tube 150 coaxially with stem 126 of valve 120 operating shaft 141 is axially slidable and circumferentially rotatable using handle 145. Opposite, or free end 142, of elongate operating shaft 141 is disposed in operative relation to stem 126 of bottom outlet valve 120. It has a square cross-sectional shape for connection and torque transfer to stem 126 as further described.

As seen in FIG. 3, tube 150 includes a control slot having an axial portion 154 joined at one end to a circumferential portion 155. As best seen in FIG. 3, rotational and axial movement of operating shaft 141 is controlled by slot portions 154 and 155 in support tube 150. Guide bolt 144, affixed to shaft 141 resides in the slots and limits shaft movement upon manipulation of operating handle 145. Axial translation of shaft 141 toward and away from bottom outlet valve 120 is defined by the axial length of slot 154 between its ends. Rotational movement is defined by the circumferential length of slot 155 between its ends. Here, circumferential slot 155 defines an arc of 90° (degrees). When handle 145 is retracted to the extent permitted by interaction of guide bolt 144 in longitudinal slot 154, the free end 142 of operating shaft 141 is withdrawn from operative association with stem 126 of valve 120 (As seen in FIGS. 1 and 4).

Turning now to FIGS. 4 to 7, coupling 160 provides for interconnection of the free end 142 of operating shaft 141 with stem or shaft 126 of bottom outlet valve 120. Coupling 160 includes a generally cylindrical body 161 with a central bore. An open end facing toward valve body 121, is defined by flats 162 slidable upon flats 128 of stem 126. Coupling 160 is therefore connected to shaft 126 in a torque transferring relation. An opposite open end, facing toward operating shaft 141 is defined by flats 163 forming a receptacle to slidably receive free end 142 of operating shaft 141.

Internal transverse wall 164 supports compression spring 165 against the free end 127 of stem 126 which urges coupling 160 away from free end 127. Axial sliding movement of coupling 160 on stem 126 is limited by the axial extent of slot 166 in body 161. Retention pin 167 within slot 166 is affixed to stem 126 and secures coupling 160 to stem 126.

The shaft end receptacle includes a bottom ridge 168. Seen in FIG. 5, contact of the free end 142 of operating shaft 141 with bottom ridge 168 within coupling 160 results in axial translation of coupling 160 along stem 126. The amount of this movement is effective to release the stem lock mechanism 170 described below to permit rotational movement of valve stem 126 to an open position.

The stem locking mechanism designated 170, comprises a torque resistance couple with closely spaced abutting force transmission and force receiving surfaces. In this regard, a generally circular cam disc 171 on the exterior of coupling body 161 includes a flat 172 along a segment of the circular cam disc 171 defining a peripheral force transmission surface. A stationary resistor plate 173 includes flat 177 comprising a force receiving surface that co-acts with flat 172 to restrict rotation of valve stem 126 when the bottom outlet valve 120 is in the closed position. The stem 126 and associated flow control element is thereby locked against rotation to an open position.

Shown in FIGS. 4, 6 and 7, resistor plate 173 is a fabricated steel plate attached to upper flange 122 of valve 120 using bolt holes 174. Plate 173 includes horizontal planar portion 175 extending parallel to stem 126 terminating in a depending flange portion 176 that defines flat force receiving surface 177 for contact with flat force transmission surface 172 of circular cam disc 171.

Planar horizontal portion 175 of resistor plate 173 includes a relief or notch 179 adjacent depending flange portion 176. Relief 179 is sized to receive the cam disc 171 and permit its free rotation with operating shaft 141 and valve stem 126.

Operation of the bottom outlet valve 120 using valve handle assembly 140 proceeds as described below. Initially, with handle 145 stowed in securement bracket 153 and free end 142 of operating shaft 141 separated from coupling 160, the stem 126 of bottom outlet valve 120 resides in the valve closed position with edges 129 of tabs 125 in contact with limit stops 124 as illustrated in FIGS. 1 and 4.

Bottom outlet valve 120 is secured against fluid flow by stem locking mechanism 170. As seen in FIGS. 4 and 5 with free end 142 of operating shaft 141 separated from coupling 160, compression spring 165 urges coupling 160 away from valve body 121 to the extent permitted by longitudinal slot 166 and retention pin 167. With stem 126 in the valve closed position, force transmission surface or flat 172 on cam disc 171 is vertical and in closely spaced abutting relation with force receiving surface 177 of resistor plate 173. Rotational effort on stem 126 of bottom outlet valve toward an open position causes force transmission contact of flat 172 and surface 177, and rotation of stem 126 is precluded.

Resistance to an applied torque upon stem 126 requires the force transmission surface 172 and force receiving surface 177 to be aligned for force transferring contact. That is, imposition of a torque upon stem 126 must cause force transmission surface or flat 172 to the urged into abutting contact with toward force receiving surface or flat 177.

Coupling 160 including cam disc 171 may be a ductile iron casting or be made from carbon steel such as CS (12L14). Based on the sizes of various commercial bottom outlet valves, the diameter of cam disc 171 may vary from between 2.75 inches (in.). to 3.50 inches (in). The length of flat 172 may vary in length from slightly more than 2.00 inches (in.) to slightly more than 3.00 inches (in.). It could also be machined from carbon steel or stainless-steel.

Plate 173 is of a material and strength to resist deformation or dislodgement by forces from an applied torque of 800 ft-lbs. It may be made of carbon steel or stainless-steel one-half inch (½ in.) to five eighths inch (⅝ in.) in thickness.

As permitted by interaction of bolt 144 and longitudinal slot 154 in support tube 150, operating shaft 141 may be axially translated into operative engagement with coupling 160 along flats 163 within the shaft receiving receptacle of coupling body 161. On reaching bottom ridge 168 within the shaft receiving receptacle, continued axial movement causes compression of spring 165 and axial translation of coupling 160 toward the outlet valve 120. Such movement results in similar axial movement of cam disc 171 and separation of flat 172 of cam disc 171 and force receiving surface 177 of resistor plate 173. Cam disc 171 aligns with notch or relief 179 within which it is freely rotatable. Notably, it is only necessary that notch or relief 179 be sized to permit rotation of cam disc 171. It is contemplated, however, that relief or notch 179 may extend completely to the arcuate surface defining the edge of resistor plate 123 at valve body 121 as illustrated by the dashed line in FIG. 6.

With cam disc 171 aligned with relief 179, stem locking mechanism 170 is deactivated. Upon guide bolt 144 reaching circumferential slot 155, shaft 141, stem 126 and associated flow control element are fully rotatable to a valve open position.

Interference of the cam disc 171 with depending flange portion 176 of plate 173 occurs in any position other than the valve closed position. This prevents spring 165 from urging cam disc 171 with flat 172 into position aligned with force receiving surface 177 unless the valve is at the closed position. Longitudinal and circumferential slot portions 154 and 155 in tube 150 prevent withdrawal of operating shaft 141 unless the stem 126 is returned to the valve closed position. The fully open position of outlet valve 120 is achieved when the opposite edges 130 of radial tabs 125 contact stops 124. (See FIG. 2)

FIGS. 8 to 12 illustrate another embodiment of a stem locking mechanism 270 in accordance with the disclosure. Whenever possible, like reference numerals refer to like elements.

Referring to FIGS. 8 and 9, bottom outlet valve 120 is positioned within a protective skid 231, associated with the tank or vessel of a railroad tank car (not shown). Skid 231 includes a pair of vertical structural steel plates 232 that run parallel to the length of a railroad car. The skid 231 is intended to protect the bottom outlet valve against damage or inadvertent opening in the event of a catastrophic occurrence. Plates 232 may include an opening 234 aligned with the axis of handle operating shaft 141 and stem 126 of the associated bottom outlet valve 120. This arrangement represents an exemplary structural environment of a railroad tank car upon which the bottom outlet valves and operational hardware of this disclosure are useful.

The bottom outlet valve 120 is substantially as described in the previous embodiment. It includes body 121 defining a flow passage and includes upper flange 122 having holes 123 to connect valve 120 to a tank car vessel. Internally, a flow control element is rotatable about an axis and controls flow. Seen in FIG. 11, shaft extension or stem 126 extends from the valve body 121 to receive manual operating input. It is movable between valve closed and open positions through an arc of 90° (degrees) defined by limit stops 124 engaged by edges 129 and 130 on tabs 125 affixed to stem 126. A free end 127 has square cross-section, with flats 128. It has a length to extend through the opening 234 in one of plates 232 of skid 231.

Bottom outlet valve 120 of the embodiment of FIGS. 8 to 12 is operated by valve handle assembly 140. Valve handle assembly 140 includes horizontally disposed support tube 150 affixed to mounting plate 246 by angle bracket 151. It may also include weld plate 152 to secure the assembly to the railroad car tank. A handle securement bracket 153 for storing operating handle 145 when not in use may be attached to a distal end of support tube 150 at weld plate 152. Notably, plate 246, best seen in FIG. 10 provides structural resistance essential to the stem locking mechanism 270 of the embodiments of FIGS. 8-12 as explained further below.

Best seen in FIGS. 8, 9 and 11, valve handle assembly includes an elongate operating shaft 141 of square cross-section extending between an end having a manipulation handle 145 at one end. Shaft 141 is supported in tube 150 for rotational and axial movement by a user employing handle 145. It is disposed coaxially with stem 126 of valve 120. As in the previous embodiment, longitudinal and circumferential slots 154 and 155 in support tube 150 control movement of shaft 141 through interaction with bolt 144 affixed to operating shaft 141.

Operating shaft 141 includes a coupling 260. Best seen in FIG. 11, coupling 260 includes a cylindrical body 261 with a center bore defined by flats within which is disposed free end 142 of operating shaft 141 affixed by cross-pin 267. Free end 268 of coupling 260 includes a square opening defined by flats 262 sized and aligned to receive stem 126 of valve 120 in driving relation.

The valve stem locking mechanism 270 of the embodiment of FIGS. 8 to 12 generally designated 270 comprises plural torque resistance couples with closely spaced abutting force transmission 287a, 287b, 288a, 288b and force receiving 277a, 277b, 278a, 278b surfaces. In this regard a locking bracket 280, best seen in FIG. 12 comprises a rectangular planar body having a central square hole 284 arranged for disposition upon valve stem 126 in axial sliding relation upon flats 128. Protruding arms 286 on either side of central hole 284 each include flats that define force transmission surfaces 287a, 287b, and 288a and 288b.

Locking bracket 280 is disposed upon valve stem 126 with arms 286 facing away from valve body 121, toward valve operating handle assembly 140. Compression coil spring 288 acting on planar body 282 urges locking bracket toward coupling 260 on operating shaft 141.

The torque resistance couples of this embodiment additionally comprise stationary force receiving elements formed upon mounting plate 246. With reference to FIG. 10 mounting plate 246 includes horizontally elongate central aperture 248 which overlies opening 234 in plate 232 of protective skid 230. Arcuate surfaces 243 define an opening sized to freely pass coupling 260 on free end 142 of operating shaft 141. Lateral reliefs are defined by horizontal force receiving surfaces 277a and 277b and 278a and 278b that comprise the stationary force receiving element of the torque resistance couples of the mechanism 270 of FIGS. 8 to 11.

As best illustrated in FIG. 8, with stem 126 and associated flow control element in the valve closed position locking bracket 280 slidably resides on stem 126 urged away from valve body 121 by spring 288. Arms 286 are disposed in the lateral reliefs of mounting plate 246 with force transmission surfaces 287 (a) and (b). Thus formed, two torque resistance couples preclude rotation of stem 126 from its closed position to a valve open position. Notably, implementation of two torque resistance couples reduce the forces at each couple by one half (½).

Additionally, and again as best seen in FIG. 8, disposition of locking bracket 280 as described also places force transmission surfaces 288a and 288b in force transmitting abutting relation with force receiving surfaces 278(a) and 278(b) thereby forming two torque resistance couples precluding rotation of valve stem 126 in an opposite direction. Again, incorporation of two torque resistance couples reduces forces at each couple by one half (½).

As in the earlier embodiment when bottom outlet valve 120 is in the valve closed position and handle 145 is retracted to the extent permitted by interaction of guide bolt 144 in longitudinal slot 154. Free end 141 including coupling 260 is withdrawn from operative association with stem 126 of bottom outlet valve 120. (See FIG. 11).

Compression coil spring 288 urges locking bracket 280 toward mounting plate 246 and places planar body 282 of locking bracket 280 in facing contact with mounting plate 246 within opening 234 of plate 232 of skid 230. Arms 286 of locking bracket 280 are disposed within lateral reliefs of mounting plate 246 with flats 287 and 288 in force transferring relation with force receiving surfaces 277 and 278 of mounting plate 246 thereby locking valve stem 126 against rotation in either rotational direction and ensuring against inadvertent spillage from valve 120.

Locking bracket 280 and mounting plate 246 of this embodiment are made to sustain the torque upon stem 126 contemplated in the most recent pronouncement of the AAR. In this regard, these components are made of suitable material such as carbon steel or stainless-steel and sized according to need. For example, these components may be at least one-half inch (½ in.) to five eighths inch (⅝ in.) in thickness.

Opening of valve 120 is initiated by axial translation of shaft 141 toward valve 120 and engagement of flats 262 of coupling 260 onto free end 127 of valve stem 126. Free end 268 of coupling 260 passes between arcuate surfaces 243 in mounting plate 246 into contact with locking bracket 280 and urges it axially toward valve 120. Arms 286 are displaced from the lateral reliefs in plate 246 disassociating flats 287 and 288 and force receiving surfaces 277 and 278. Stem 126 is no longer restricted against rotation. Once bolt 144 is aligned with circumferential slot 155 in support tube 150, operating handle 145 may be rotated (clockwise) to move the flow control element of the bottom outlet valve 120 to an open position.

Turning now to FIGS. 13 to 17 there is illustrated a further embodiment of a bottom outlet valve stem locking mechanism 370. FIG. 13 shows a bottom outlet valve 120 positioned within protective skid 230 between vertical plates 232 and aligned with an opening 234. Valve 120 is substantially as described in connection with the previously described and illustrated embodiments.

Rotatable valve stem 126, seen in FIG. 14, extends from valve body 121 for manual input from valve handle assembly 140, best seen in FIG. 13. As in earlier illustrated embodiments, stem 126 is rotatable between valve closed and open positions through an arc of 90° (degrees). Stem 126 is of square cross-section and is coaxially aligned with operating shaft 141 of valve handle assembly 140.

As in earlier illustrated embodiments shaft 141 is supported in tube 150 affixed to skid plate 232 by angle bracket 151. Manual manipulation of valve stem 126 is imparted through shaft 141 employing attached handle 145. Operating shaft 141 includes a distal or free end 142 engageable with stem 126 of bottom outlet valve 120. As illustrated in FIG. 13 when the valve 120 is in the closed position and operating handle 145 stowed in securement bracket 153 free end 142 of shaft 141 is separated from stem 126 of valve 120.

Operative connection of handle shaft 141 to valve 120 is achieved through coupling 360, affixed upon valve stem 126. Best seen in FIG. 15, coupling 360 has a generally cylindrical body 361 having stem end opening defined by flats 362. Coupling 360 is affixed to end of stem 126 of valve 120 for rotation with the stem by a suitable fastener such as a cross-bolt or a spring pin 364. (See FIG. 14)

An opposite end of coupling 360 includes an opening defined by flats 363 configured to receive free end 142 of shaft 141 in driving relation. Coupling body 361 includes transverse bore 369 through body 361 adjacent the end of the opening defined by flats 363.

A sleeve or bushing 346 best seen in FIG. 16 is disposed within opening 234 in skid plate 332. It extends outwardly toward handle assembly 140 coaxial to the stem 126 of valve 120. It includes central bore 348 sized to receive coupling 360 in freely rotatable relation. An end extending from plate 232 includes a horizontal bore 343 through the sleeve body. Sleeve 346 may be a section of double walled steel pipe having a three inch (3 in.) outer diameter. It may be held in place by welding to vertical plate 232 within opening 234.

Shown in FIG. 17, a seal pin 390 comprises the final component of the stem locking mechanism 370. It includes a steel shaft 392 approximately five eighths inch (⅝ in.) in diameter with a hinged tab 394 which hinders its removal once inserted in place.

In this embodiment, with valve 120 in the closed position, transverse bore 369 of coupling 360 on stem 126 is horizontally aligned with bore 343 through sleeve 346. As seen in FIGS. 13 and 14, pin 390 inserted through bore 343 and bore 369 locks valve stem 126 against rotation from the valve closed position. Coupling 360, sleeve 346 and pin 390 are of sufficient strength to ensure safe retention of the valve stem 160 and valve flow control element against external forces.

As is also evident, the presence of locking pin 390 prevents axial movement of free end 142 of operating shaft 141 into operative engagement with sleeve 360. On removal of pin 390, shaft end 142 may be engaged with coupling 360 and handle assembly 140 employed to rotate bottom outlet valve stem 126 and associated flow control element to an open position.

FIGS. 18-21 illustrate a modified form of valve stem locking mechanism 470 in accordance with the disclosure. Certain details of this embodiment are presented above in the description of the embodiment illustrated in FIGS. 1 to 7. The content of the specification and accompanying drawings referencing FIGS. 1 to 7 are applicable to the discussion here of the embodiment of FIGS. 18-21. Where possible, like reference numerals refer to like elements.

Bottom outlet valve 120 and handle operating mechanism 140 are secured within protective skid 231 of a railroad tank containment vessel. A valve stem locking mechanism generally designated 470 comprises a torque resistance couple with closely spaced abutting force transmission and force receiving surfaces. The locking mechanism 470 provides protection against unwanted dislodgment of the outlet valve flow control element to an open position. The components of this embodiment are essentially the same as those of the embodiment of FIGS. 1 to 7 except for differences described below.

As in the embodiment of FIGS. 1 to 7, stem 126 of bottom outlet valve 120 includes axially translatable coupling 160 for operative connection with operating shaft 141 of handle operating mechanism 140. As described in connection with the embodiment of FIGS. 1 to 7 coupling 160 is rotatable with, and slidable upon stem 126 within limits defined by longitudinal slot 166 and retention pin 167. As seen in FIG. 5 distal or free end of coupling 160 defines a receptacle to receive free end 142 of operating shaft 141 up to bottom ridge 168. Coupling 160 is biased away from valve 120 by a compression spring such as spring 165 seen in FIG. 5.

As in the earlier embodiment of FIGS. 1 to 7, stem locking mechanism 470 includes torque transmitting disc 171 on the exterior of coupling body 161. Flat 172 representing a segment of circular cam disc 171 comprises a peripheral force transmission surface.

The modification of the stem locking mechanism 470 of the embodiments of FIGS. 18 to 21 is the elimination of resistor plate 173 of the embodiment of FIGS. 1 to 7 and the addition of resistor block 473.

As seen in FIGS. 18 to 21 stem locking mechanism 470 includes resistor block 473 disposed in close relation to the cam disc 171 of coupling 160. A planar surface 475 is affixed to vertical plate 232 of protective skid 231 by welding or other suitable means. Block 473 includes a vertical force receiving surface or flat 477. With valve stem 126 in the valve closed position, force transmission flat 172 of circular cam disc 171 is vertical and disposed in closely spaced facing relation with flat surface 477 to preclude rotation of stem 126 of bottom outlet valve 120 toward a valve open position.

The axial extent of force receiving surface 477 of block 473 between planar surface 475 and distal surface 479 along the axis of stem 126 and operating shaft 140 to outer surface 479 is such that translation of coupling 160 along stem 126 frees cam disc 171 for rotational movement. The vertical extent of surface 477 need not be co-extensive with the length of flat 172 of cam disc 171 but must be adequate to resist contemplated forces imparted by rotational effort upon stem 126. Moreover, as best illustrated in FIG. 19 the block 473 must be positioned to provide a force transfer relation between surface 172 of disc 171 and flat 477 of block 473.

Block 473 is made of carbon steel, stainless-steel or similar material of sufficient strength to withstand the forces contemplated by the applicable AAR safety standards.

Operation of the bottom outlet valve 120 of the embodiment of FIGS. 18 to 24 employing valve handle assembly 140 proceeds as described above in connection with the embodiment of FIGS. 1 to 7. The main difference is that rotation of the valve stem 126 from its closed to an open position requires axial translation of cam disc 171 on coupling 160 beyond block surface 479.

FIGS. 22 to 26 illustrate a further modified form of valve stem locking mechanism 570 in accordance with the disclosure. Details of this embodiment are presented above in the description of the embodiment illustrated in FIGS. 1 to 7 and 18 to 21. The content of the specification and accompanying drawings referencing these figures are applicable to the discussion here of the embodiment of FIGS. 22 to 26. Where possible, like reference numerals refer to like elements.

Bottom outlet valve 120 and handle operating mechanism 140 are secured within protective skid 231 of a railroad tank containment vessel. A valve stem locking mechanism generally designated 570 comprises plural torque resistance couples with closely spaced abutting force transmission and force receiving surfaces. The locking mechanism 570 provides protection against unwanted dislodgment of the outlet valve flow control element to an open position. The components of the embodiment are essentially the same as the embodiment of FIGS. 1 to 7 and 18 to 21 except for differences described below.

As in the embodiment of FIGS. 18 to 21 stem 126 of bottom outlet valve 120 includes axially translatable coupling 160 for operative connection with operating shaft 141 of handle operating mechanism 140. As described in connection with the embodiment of FIGS. 1 to 7 coupling 160 is rotatable with, and slidable upon stem 126 within limits defined by longitudinal slot 166 and retention pin 167. As seen in FIG. 5 distal or free end of coupling 160 defines a receptacle to receive free end 142 of operating shaft 141 up to bottom ridge 168. Coupling 160 is biased away from valve 120 by a compression spring such as spring 165 seen in FIG. 5.

As best seen in FIG. 26, stem locking mechanism 570 includes torque transmitting disc 571 on the exterior of coupling body 161. Flats 572 and 578 each representing segments of circular cam disc 571 comprise peripheral force transmission surfaces.

The modification here, relative to the stem locking mechanism 470 of the embodiments of FIGS. 18 to 21 is the addition of flat 578 on cam disc 571 and the addition of additional resistor block 573.

As seen in FIGS. 22 to 25, second resistor block 573 is disposed in close relation to the cam disc 571 of coupling 160. A planar surface 575 is affixed to vertical plate 232 of protective skid 230 by welding or other suitable means. Each block 473 and 573 includes a vertical force receiving surface or flat 477 and 577. With valve stem 126 in the valve closed position, force transmission flats 572 and 578 of generally circular cam disc 571 are vertical and disposed in closely spaced facing relation to flat surfaces 477 and 577 to preclude rotation of stem 126 of bottom outlet valve 120 toward a valve open position.

The axial extent of force receiving surfaces 477 of block 473 and 577 of block 573 along the axis of stem 126 and operating shaft 140 to outer surface 479 and 579 of blocks 473 and 573 are such that translation of coupling 160 along stem 126 frees cam disc 571 for rotational movement. The vertical extent of surfaces 477 and 577 need not be co-extensive with the length of flats 572 and 578 of cam disc 571 but must be adequate to resist contemplated forces imparted by rotational effort upon stem 126. Moreover, as best illustrated in FIG. 19 or 23 the blocks 473 and 573 must be positioned to provide a force transfer relation between surface 572 of disc 571 and flat 477 of block 473 as well as surface 578 of disc 571 and flat 577 of block 573.

Blocks 473 and 573 may be made of carbon steel, stainless-steel or similar material of sufficient strength to withstand the forces contemplated by the applicable safety standards. As in the embodiment of FIG. 2 this embodiment provides two torque resistance couples to resist forces resulting from torque upon the stem 126 of a bottom outlet valve 120 urging it toward an open position. This configuration reduces the load on each torque resistance couple by one half. Moreover, it is contemplated that if desired, additional torque resistance couples could be employed, for example three to six, or more, to further distribute resistance load.

The axial extent of angle brackets 673 and 773 is such that axial translation of coupling 160 toward valve 120 as explained with respect to previous embodiments the stem locking mechanism is disengaged to permit rotation of valve stem 126 employing handle operating mechanism 140. Disengagement requires axial translation of cam disc 571 on coupling 160 of the embodiment illustrated in FIGS. 22 to 26 beyond angle bracket surfaces 679 and 779.

Operation of the bottom outlet valve 120 of the embodiments of FIGS. 18 to 26 employing valve handle assembly 140 proceeds as described above in connection with the embodiment of FIGS. 1 to 7. The main difference is that rotation of the valve stem 126 from its closed to an open position requires axial translation of cam disc 571 on coupling 160 beyond block surfaces 479 and 579.

It should be noted that the disclosed use of blocks to provide force receiving surfaces such as the blocks 473 and 573 of the torque resistance couples of the embodiments of FIGS. 18 to 26 are merely exemplary and not limiting. It is contemplated that any suitable structure may be employed to provide torque resistance couples having force receiving surfaces such as the force receiving surfaces 477 and 577.

As shown in FIG. 27, force receiving surfaces defined by angle brackets 673 and 773 welded to the skid plate 232 are well suited to use in this manner. The illustrated angled brackets 673 and 773 with force receiving surfaces 677 and 777 may be substituted in the embodiment of FIGS. 22 to 25 for blocks 473 and 573. In this regard, it is contemplated that angle brackets 673 and 773 may be created using portions of an angle bracket length used to create the angle bracket 151, best seen in FIGS. 1, 9 and 13.

The angle brackets shown, made from carbon steel, stainless-steel or the like define force receiving surfaces 677 and 777 disposed in closely spaced abutting force transferring relation to force transmission surfaces such as 572 and 578 of cam disc 571 seen in FIG. 26. Again, a stem locking mechanism is provided in accordance with the disclosure that provides plural torque resistance couples to reduce force upon the force transfer components.

It is further contemplated that if desired two additional angle brackets may be positioned at opposite quadrants of the arrangement as illustrated in FIG. 27 to co-act with flats 572 and 578 to preclude rotation of stem 126 of bottom outlet valve 120 in an opposite direction. These locations are illustrated by dotted lines 873 and 973 in FIG. 27.

The mechanisms disclosed herein, and the processes carried out include various well-known components, features and operating parameters commonly associated with operating handles for bottom outlet valves. Though not specifically discussed, or shown in the accompanying drawings, these elements are considered inherent to the disclosure and fully understood by persons of ordinary skill in the art.

The terms “comprising,” “having,” “including,” and “containing” are to be construed as open-ended terms (i.e., meaning “including, but not limited to,”) unless otherwise noted. Recitation of specific values or ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve stem locking mechanism for an outlet valve including a stem and associated flow control element in which rotation of the stem controls movement of the associated flow control element to selectively transition the outlet valve to and from a closed position and an open position, the stem extending from a surface of the outlet valve, the valve stem locking mechanism comprising:
a coupling connectable to the stem and configured for axially translation along the stem;
at least one torque resistance couple configured to restrict or prevent rotation of the stem and associated flow control element when in the outlet valve is in the closed position, the at least one torque resistance couple comprising:
a rotatable force transmission element formed on the coupling; and
a stationary force receiving element formed on a portion of the outlet valve in proximity to the stem;
wherein, when the coupling is axially translated along the stem towards the valve outlet, the rotatable force transmission element and the stationary force receiving element are in a same rotational path so as to co-act by physically abutting against each other to restrict or prevent rotation of the stem; and
wherein, when the coupling is axially translated along the stem away from the valve outlet, the rotatable force transmission element and the stationary force receiving element are not in the same rotational path and do not restrict or prevent rotation of the stem.

2. The valve stem locking mechanism of claim 1, wherein:
the rotatable force transmission element is a cam disc with a flat;
the stationary force receiving element is a stationary plate with a flat; and
the flat of the rotatable force transmission element and the flat of the stationary force receiving element co-act by physically abutting against each to restrict or prevent rotation of the stem.

3. The valve stem locking mechanism of claim 1, wherein:
the rotatable force transmission element is a cam disc with a flat;
the stationary force receiving element is a resistor block with a flat; and
the flat of the rotatable force transmission element and the flat of the stationary force receiving element co-act by physically abutting against each to restrict or prevent rotation of the stem.

4. The valve stem locking mechanism of claim 1, wherein:
the rotatable force transmission element is a cam disc with a flat;
the stationary force receiving element includes two resistor blocks, each with a flat; and
the flat of the rotatable force transmission element and the flats of the stationary force receiving element co-act by physically abutting against each to restrict or prevent rotation of the stem.

5. The valve stem locking mechanism of claim 1, further comprising:
a spring to bias the coupling away from the outlet valve.

6. A valve stem locking mechanism for an outlet valve including a stem and associated flow control element in which rotation of the stem controls movement of the associated flow control element to selectively transition the outlet valve to and from a closed position and an open position, the stem extending from a surface of the outlet valve, the valve stem locking mechanism comprising:
a coupling connectable to the stem;
plural torque resistance couples configured to restrict or prevent rotation of the stem and associated flow control element when in the outlet valve is in the closed position, the plural torque resistance couples comprising:
a rotatable force transmission element formed on the coupling and configured for axially translation along the stem; and
a stationary force receiving element formed on a portion of the outlet valve in proximity to the stem;
wherein, when the rotatable force transmission element is axially translated along the stem towards the valve outlet, the rotatable force transmission element and the stationary force receiving element are in a same rotational path so as to co-act by physically abutting against each other to restrict or prevent rotation of the stem; and
wherein, when the rotatable force transmission element is axially translated along the stem away from the valve outlet, the rotatable force transmission element and the stationary force receiving element are not in the same rotational path and do not restrict or prevent rotation of the stem.

7. The valve stem locking mechanism of claim 6, wherein:
the rotatable force transmission element is a locking bracket with a hole to receive the stem in axial translation and plural flats;
the stationary force receiving element is a mounting plate with a plural receiving surfaces; and
the plural flats of the rotatable force transmission element and the plural receiving surface of the stationary force receiving element co-act by physically abutting against each to restrict or prevent rotation of the stem.

8. The valve stem locking mechanism of claim 6, further comprising:
a spring to bias the rotatable force transmission element away from the outlet valve.

9. A valve stem locking mechanism for an outlet valve including a stem and associated flow control element in which rotation of the stem controls movement of the associated flow control element to selectively transition the outlet valve to and from a closed position and an open position, the stem extending from a surface of the outlet valve, the valve stem locking mechanism comprising:
a coupling connectable to the stem, the coupling including a coupling bore;
a sleeve connectable to a portion of the outlet valve, the sleeve including a sleeve bore, the sleeve configured to receive the coupling in a freely rotational arrangement;
a pin configured to be inserted through the coupling bore and the sleeve bore;
wherein, when the pin is inserted through the coupling bore and the sleeve bore, the valve stem locking mechanism restricts or prevents rotation of the stem.
